(19) United States
(12) Patent Application Publication
(10) Pub. No.: US 2020/0309072 A1
(43) Pub. Date: Oct. 1, 2020

(54) PERMANENT MAGNETIC DEVICE FOR ENHANCING BURNING OF COMBUSTION MATERIAL PARTICLES

(71) Applicant: Electronic Design Land Trading GMBH, Apia (WS)

(72) Inventor: HUNG-YU LIN, New Taipei City (TW)

(21) Appl. No.: 16/689,116

(22) Filed: Nov. 20, 2019

(30) Foreign Application Priority Data
Mar. 26, 2019 (TW) 108110511
Jun. 19, 2019 (TW) 108121376

(51) Int. Cl. F02M 27/04; B01F 13/08

(52) U.S. Cl. CPC F02M 27/045; B01F 2215/0086; B01F 13/0809

(57) ABSTRACT

Disclosed is a permanent magnetic device for enhancing burning of combustion material particles, comprising: a barrel-shape permanent magnetic device, and that includes a near barrel magnet, a distant barrel magnet adjacent to each other, and a first hollow cylinder space formed in a center of the near barrel magnet and the distant barrel magnet respectively, for a combustion material supply pipe to pass through; the near barrel magnet is provided with a near N pole and a near S pole, the near N pole is adjacent to a combustion device, the distant barrel magnetic is provided with a distant N pole and a distant S pole, the distant N pole is adjacent to the near S pole; and first magnetic field lines are formed by the barrel-shape permanent magnetic device.

### BACKGROUND OF THE INVENTION

### Field of the Invention

The preferred embodiment of the present invention relates to a magnetic device, and in particular to a permanent magnetic device for enhancing burning of combustion material particles.

### The Prior Arts

It is well known that, fuel is a kind of energy resource, that is able to release its latent energy through chemical or nuclear reactions. The applications of the fuel are numerous, for example liquid fuel is used for transportation (such as vehicle) and heating, and it is an important resource for the chemical industry. While gas fuel (such as natural gas) is used in our daily life, for instance heating and power generation. Besides, gas fuel is also an important fuel and raw material for the chemical industry.

However, when liquid fuel is used as an energy source for a vehicle, usually, petroleum refined product is utilized. For which, the liquid fuel is input into an engine room to be mixed with air to become gasified mist. Then, gasified mist is ignited or compressed into explosion to produce kinetic energy. Yet, carbon tends to deposit on the inner wall of the cylinder due to incomplete combustion of fuel. When carbon is deposited too much, the output exhaust gas could cause environment pollution. This phenomenon could also affect adversely the power output efficiency of the internal combustion engine, and cause serious abrasion to the internal combustion engine. In order to solve this problem, various approaches are adopted, such as adding combustion enhancing agent, or carbon removal agent.

In case of complete combustion of gas fuel such as natural gas, non-toxic carbon dioxide is produced; yet for the incomplete combustion of gas fuel such as natural gas, toxic carbon dioxide is produced to cause pollution of the environment.

For the technology of reducing carbon monoxide (CO) or hydrocarbon (CH) contained in vehicle exhaust or natural gas, two approaches are available presently for further activating the particles of combustion material. Wherein, the first approach is “magnetism agitation”, and that utilizes the magnetism of the magnet to act on the combustion material particles, to make the particles more active through using the magnetic field line, to raise its combustion efficiency. The shortcoming of this approach is that, the magnetic field lines are only able to make the particles more active, yet they are not able to break the particles into minute particles, therefore, the effectiveness of this approach is rather limited. As such, in order to be effective enough, large size magnet must be used, hereby occupying large space. The second approach is “far-infrared ray agitation”, to overcome the deficiency of the “magnetism agitation”. This approach utilizes ceramic that emits far-infrared ray, to make the combustion material particles more active, and to raise their combustion efficiency. Though this approach is more effective than the previous one, yet its service life is rather limited, while the intensity of the far-infrared ray will decrease with time. In general, man-made artificial far-infrared ray material is able to sustain operation for half a year, while the natural far-infrared ray material is able to last longer, yet its cost is fairly high, and thus it is not suitable to be commercialized. Further, in applications some of the ceramics are required to be heated, to be able to emit the far-infrared ray. However, heating requires electricity, thus raising its operation cost.

Therefore, presently, the design and performance of the device for enhancing burning of combustion material particles is not quite satisfactory, and it leaves much room for improvements.

### SUMMARY OF THE INVENTION

In view of the problems and drawbacks of the prior art, the preferred embodiment of the present invention provides a permanent magnetic device for enhancing burning of combustion material particles, to overcome the shortcomings of the prior art.

In the preferred embodiment of the present invention, particles of combustion material are subject to stirrings and agitations produced by the permanent magnetic device, and the energy waves thus incurred are able to break the molecular bonds of the molecular clusters for the combustion material particles, so that large molecular cluster is broken into minute molecules. Then, the minute molecules are ionized into ions carrying positive charges. Therefore, the embodiment of the present invention is able to split the particles of the combustion material into minute particles, and then ionize the minute particles into ions carrying positive charges, thus being able to expedite and enhance their combustion reactions with the electrons carrying negative charges for the spark plug, as such raising their combustion efficiency.

In order to achieve the objectives mentioned above, the present invention provides a permanent magnetic device for enhancing burning of combustion material particles, comprising: a barrel-shape permanent magnetic device, and that includes a near barrel magnet, a distant barrel magnet adjacent to each other, and a first hollow cylinder space formed in a center of the near barrel magnet and the distant barrel magnet respectively, for a combustion material supply pipe to pass through; the near barrel magnet is provided with a near N pole and a near S pole, the near N pole is adjacent to a combustion device, the distant barrel magnetic is provided with a distant N pole and a distant S pole, the distant N pole is adjacent to the near S pole; and first magnetic field lines are formed by the barrel-shape permanent magnetic device, the first magnetic field lines are originated from the near N pole, and they enter into the distant S pole through outside space, then the first magnetic field lines pass through the distant N pole, and they enter into the near S pole through a first contact face; when the combustion material particles passes through the distant barrel magnet, the first contact face, and the near barrel magnet, the particles are subject to a series of magnetic field variations, to enhance the stirrings and agitations of the particles, to break and split the particles into minute particles.

Compared with the conventional permanent magnetic device for enhancing burning of combustion material particles, the present invention has the following advantages:

1. The present invention utilizes the rare earth permanent magnet rubidium (Rb)-iron (Fe)-boron (B) and the rare earth permanent magnet samarium (Sm)-cobalt (Co). Wherein, the Gauss effect, coercivity, and the catalyst oscillation efficiency for the rare earth permanent magnet rubidium (Rb)-iron (Fe)-boron (B) are better.

2. The present invention is capable of breaking or splitting combustion material molecular cluster into minute particles, thus, enabling the combustion material mist and the air to mix more thoroughly, and raising the mixing rate of the combustion material particles and the oxygen molecules, so that the combustion of the combustion material is faster and more complete, to raise the combustion efficiency. Further, the power output of the internal combustion engine can be increased, and the exhausts of monoxide (CO) and hydrocarbon (CH) can be reduced, in achieving lower energy consumption.

3. The present invention is capable of raising the combustion efficiency of a direct-injection internal combustion engine to as high as 95%.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

Embodiments of the present invention are described below, by way of example only, with reference to the accompanying drawings; in which:

FIG. 1 is a schematic diagram of a permanent magnetic device for enhancing burning of combustion material particles according to the present invention;

FIG. 2 is a schematic diagram of a permanent magnetic device for enhancing burning of combustion material particles in application according to the present invention;

FIG. 3 is a schematic diagram of permanent magnetic device for enhancing burning of combustion material particles for Embodiments 1 and 3 according to the present invention;

FIG. 4 is a schematic diagram of a magnetic field lines produced by a barrel-shape permanent magnetic device as shown in FIG. 3 according to the present invention;

FIG. 5 is a schematic diagram showing the combustion material particles formed into combustion material ions carrying positive charges according to the present invention;

FIG. 6 is a schematic diagram of permanent magnetic device for enhancing burning of combustion material particles for Embodiments 2 and 4 according to the present invention;

FIG. 7 is a schematic diagram of the magnetic field lines formed by the four-magnet-set permanent magnetic device of FIG. 6 according to the present invention; and

FIG. 8 is a schematic diagram of a permanent magnetic device for enhancing burning of combustion material particles according to the present invention, wherein the combustion material supply pipe is a natural gas supply pipe, and the combustion device is a natural gas application device.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

### Embodiment 1

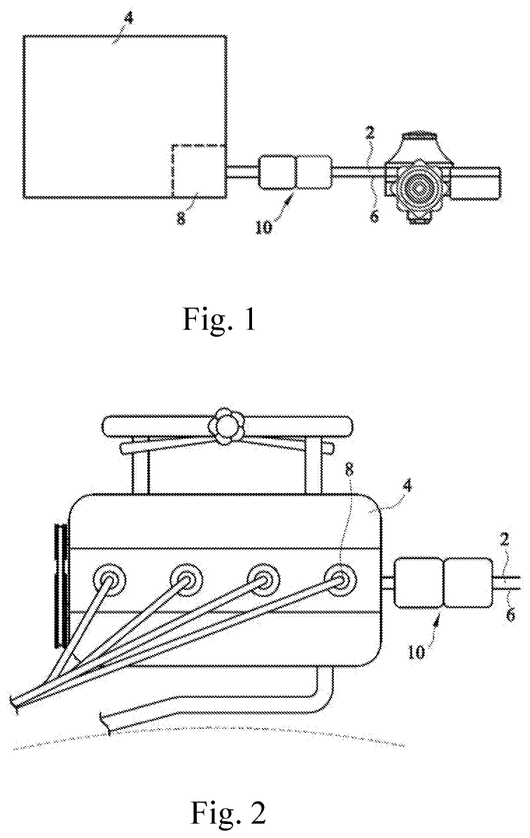

FIGS. 1-4 show the first embodiment of a permanent magnetic device for the enhancing burning of combustion material particles according to the present invention. Wherein, FIG. 1 is a schematic diagram of a permanent magnetic device for enhancing burning of combustion material particles according to the present invention. As shown in FIG. 1, a combustion material supply pipe 2 is connected to the combustion device 4, for supplying combustion material to the combustion device 4. The combustion device 4 contains an ignition device 8, and a barrel-shape permanent magnetic device 10 is disposed on a pipe outer wall 6 of the combustion material supply pipe 2.

Next, refer to FIG. 2 for a schematic diagram of a permanent magnetic device for enhancing burning of combustion material particles in application according to the present invention. As shown in FIG. 2, in Embodiment 1, the combustion material supply pipe 2 is a combustion oil supply pipe, while combustion device 4, is an internal combustion engine.

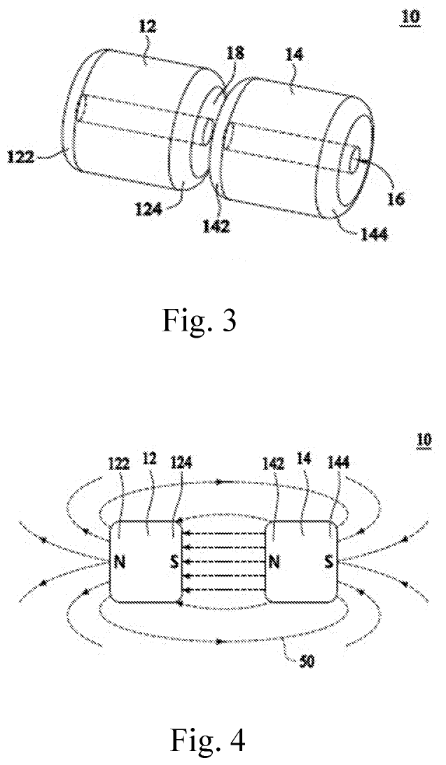

Then, refer to FIG. 3 for a schematic diagram of permanent magnetic device for enhancing burning of combustion material particles for Embodiments 1 and 3 according to the present invention. As shown in FIG. 3, the barrel-shape permanent magnetic device includes a near barrel magnet 12, a distant barrel magnet 14, and a first hollow cylinder space 16 formed in a center of the near barrel magnet 12 and the distant barrel magnet 14 respectively, for a combustion material supply pipe 2 to pass through. The near barrel magnet 12 is provided with a near N pole 122 and a near S pole 124, and the near N pole 122 is adjacent to an internal combustion engine 4. The distant barrel magnetic 14 is provided with a distant N pole 142 and a distant S pole 144, the distant N pole 142 is adjacent to the near S pole 124. A first contact face 18 is disposed between the near barrel magnet 12 and the distant barrel magnet 14. The combustion material particle 20 is a kerosene molecule, a gasoline molecule, or a diesel molecule.

Subsequently, refer to FIG. 4 for a schematic diagram of a magnetic field lines produced by a barrel-shape permanent magnetic device as shown in FIG. 3 according to the present invention. As shown in FIG. 4, first magnetic field lines 50 are formed by the barrel-shape permanent magnetic device. The first magnetic field lines 50 are originated from the near N pole 122 of the near barrel magnet 12, and it enters into the distant S pole 144 through outside space. Then, the first magnetic field lines 50 pass through the distant barrel magnet 14 to reach the distant N pole 142, and it enters into the near S pole 124 through outside space.

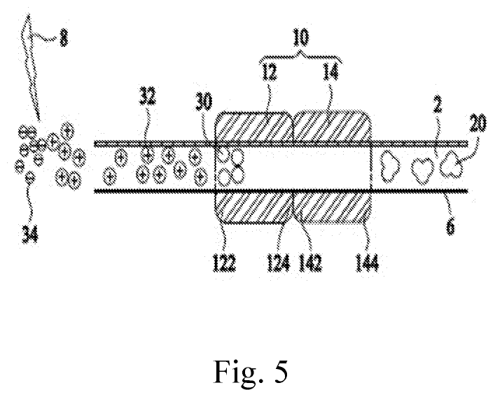

Then, refer to FIG. 5 for a schematic diagram showing the combustion material particles formed into combustion material ions carrying positive charges according to the present invention. As shown in FIG. 5, when the combustion material particles 20 in the combustion material supply pipe 2 pass through the first magnetic field lines 50 formed by the barrel-shape permanent magnetic device 10, they are subjected to a series of magnetic field variations by the distant barrel magnet 14, the first contact face 18, and the near barrel magnet 12. At first, the combustion material particles 20 could sense the magnetic field slightly when approaching the distant S pole 144, and then the particles 20 enters into a non-magnetic region through the first contact face 18 between the distant N pole 142 and the near S pole 124. Due to the instantaneous variations of the magnetic field, the particles 20 are subjected to stirrings and agitations, such that the combustion material particles 20 are agitated into breaking and splitting into minute particles 30. Subsequently, the agitated and stirred minute particles 30 arrive at the near N pole 122, to be magnetized into combustion material ions 32 carrying positive charges. Finally, when the combustion material ions 32 carrying positive charges meet the electrons 34 carrying negative charges produced by the ignition device 8 in the internal combustion engine 4, they react with each other to raise the combustion efficiency of the particles 20.

### Embodiment 2

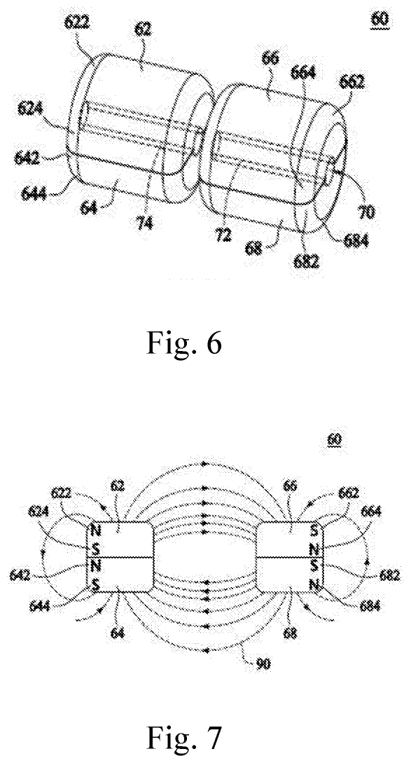

Refer to FIG. 6 for a schematic diagram of permanent magnetic device for enhancing burning of combustion material particles for Embodiments 2 and 4 according to the present invention. As shown in FIG. 6, the four-magnet-set permanent magnetic device 60 includes a left-upper-half barrel magnet 62, a left-lower-half barrel magnet 64, a right-upper-half barrel magnet 66, a right-lower-half barrel magnet 68, and a second hollow cylinder space 70 formed in the barrel magnets mentioned above. The second hollow cylinder space 70 is used for the combustion material supply pipe 2 to pass through. The left-upper-half barrel magnet 62 and the left-lower-half barrel magnet 64 are arranged adjacent to the internal combustion engine. The left-upper-half barrel magnet 62 is provided with a left-upper N pole 622 and a left-upper S pole 644. The left-lower-half barrel magnet 64 is provided with a left-lower N pole 642 and a left-lower S pole 644. The right-upper-half barrel magnet 66 is provided with a right-upper S pole 662 and a right-upper N pole 664. The right-lower-half barrel magnet 68 is provided with a right-lower S pole 682 and right-lower N pole 684 A second contact face 72 is disposed between the right-upper-half barrel magnet 66 and the right-lower-half barrel magnet 68. And a third contact face 74 is disposed between the left-upper-half barrel magnet 62 and the left-lower-half barrel magnet 64.

Refer to FIG. 7 for a schematic diagram of the magnetic field lines formed by the four-magnet-set permanent magnetic device of FIG. 6 according to the present invention. As shown in FIG. 7, the second magnetic field lines 90 are formed by the four-magnet-set permanent magnetic device 60. When the combustion material particles 20 pass through the right-upper-half barrel magnet 66, the right-lower-half barrel magnet 68, the second contact face 72, the left-upper-half barrel magnet 62, the left-lower-half barrel magnet 64, and the third contact face 74, the particles 20 are subjected to a series of magnetic field variations, to enhance the stirring and agitations of the particles, to break and split the particles 20 into minute particles 30.

As described in the Embodiment 1, when the combustion material particles 20 pass through the right-upper-half barrel magnet 66, the right-lower-half barrel magnet 68, the second contact face 72, the left-upper-half barrel magnet 62, left-lower-half barrel magnet 64, and the third contact face 74, a series of magnetic field variations are caused by the second magnetic field line 90, to expedite and enhance the stirring and agitations of the combustion material particles 20, so that the particles 20 are agitated into minute particles 30, and that are magnetized to form combustion material ions 32 carrying positive charges. Finally, when the combustion material ions 32 carrying positive charges meet the electrons 34 carrying negative charges produced by the ignition device 8 in the internal combustion engine 4, and they react with each other to raise the combustion efficiency of the particles 20.

The first and second embodiments of the present invention utilize the rare earth permanent magnet rubidium (Rb)-iron (Fe)-boron (B) and the permanent magnetic samarium (Sm)-cobalt (Co). Wherein, the Gauss effect, coercivity, and the catalyst frequency oscillation efficiency for the permanent magnetic rubidium (Rb)-iron (Fe)-boron (B) of rare earth are better. The permanent magnetic device for enhancing burning of combustion material particles of the present invention is capable of breaking or splitting the combustion material molecular cluster into minute particles 30, thus, enabling the combustion material mist and the air to mixed more thoroughly, and raising the mixing rate of the combustion material particles and the oxygen molecules, so that the combustion of the combustion material is faster and more complete, to raise the combustion efficiency, and reduce the exhausts of Further, the power output of the internal combustion engine is increased, and the exhausts of monoxide and hydrocarbon are reduced, in achieving lower energy consumption. By using the permanent magnetic device of the present invention, the combustion efficiency of a direct-injection internal combustion engine can reach as high as 95%.

The following table is test results of fuel efficiency obtained by installing the permanent magnetic device onto vehicles of various brands (makes):

| | Brand (make): FUSO | Brand (make): VOLVO |
|---|---|---|
| | License Plate | License Plate |
| Duration | Number: KLE2592 | Number: KNA3397 |
| Average Fuel | 3.16 | 2.87 |
| Consumption | | |
| AVG | | |
| 7/19-7/25 | 3.04 | 3.10 |
| Fuel Saving | 7.8% | 8.1% |
| Ratio | | |
| 7/26-8/1 | 3.39 | 3.10 |
| Fuel Saving | 7.3% | 8.1% |
| Ratio | | |
| 8/2-8/6 | 3.34 | 3.08 |
| Fuel Saving | 6.0% | 7.5% |
| Ratio | | |

### Embodiment 3

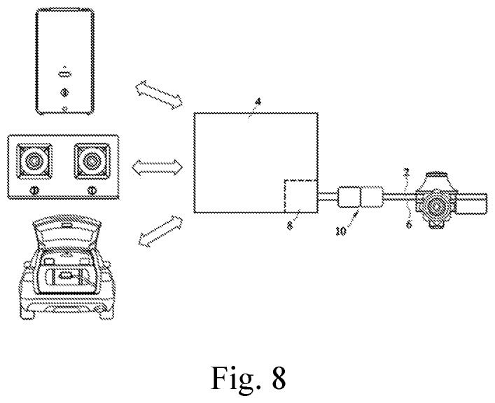

As shown in FIG. 8, the combustion material supply pipe 2 is a natural gas supply pipe; while the combustion device 4 is a natural gas application device 4. The combustion material supply pipe 2 is connected to the natural gas application device 4, to supply natural gas (gas) to the natural gas application device 4. Wherein, natural gas application device 4 can be a gas stove, a water heater, or a gas vehicle, but the present invention is not limited to this. The natural gas application device 4 is provided with an ignition device 8, and the outer wall 6 of the combustion material supply pipe 2 is provided with a barrel-shape permanent magnetic device 10.

As the same as shown in FIG. 3, the barrel-shape permanent magnetic device includes a near barrel magnet 12, a distant barrel magnet 14, and a first hollow cylinder space 16 formed in a center of the near barrel magnet 12 and the distant barrel magnet 14, for a combustion material supply pipe 2 to pass through, to supply natural gas to the natural gas application device 4.

The near barrel magnet 12 is provided with a near N pole 122 and a near S pole 124, and the near N pole 122 is adjacent to a natural gas application device 4. The distant barrel magnetic 14 is provided with a distant N pole 142 and a distant S pole 144, the distant N pole 142 is adjacent to the near S pole 124. A first contact face 18 is disposed between the near barrel magnet 12 and the distant barrel magnet 14.

The FIG. 4 shows the magnetic field lines formed by the barrel-shape permanent magnetic device of the Embodiment 3 in FIG. 8. The first magnetic field lines 50 are originated from the near N pole 122, and they enter into the distant S pole 144 through an outside space. Then, the first magnetic field lines 50 pass through the distant N pole 142 of the distant barrel magnet 14, and they enter into the near S pole 124 through the outside space.

Refer to FIG. 5 for a schematic diagram showing the combustion material particles formed into combustion material ions carrying positive charges according to the present invention. As shown in FIG. 5, when the combustion material particles 20 in the combustion material supply pipe 2 pass through the first magnetic field lines 50 formed by the barrel-shape permanent magnetic device 10, they are subjected to a series of magnetic field variations caused by the distant barrel magnet 14, the first contact face 18, and the near barrel magnet 12. At first, the combustion material particles 20 could sense a weak magnetic field when approaching the distant S pole 144, and then the particles 20 enter into a non-magnetic region through the first contact face 18 between the distant N pole 142 and the near S pole 124. Due to the instantaneous variations of the magnetic field, the particles 20 are subjected to stirrings and agitations, such that the combustion material particles 20 are agitated into breaking and splitting into minute particles 30. Subsequently, the agitated and stirred minute particles 30 arrive at the near N pole 122, to be magnetized into combustion material ions 32 carrying positive charges. Finally, when the combustion material ions 32 carrying positive charges meet the electrons 34 carrying negative charges as produced by the ignition device 8 in the natural gas application device 4, and they react with each other to raise the combustion efficiency of the particles 20.

### Embodiment 4

Refer to FIG. 6 for a schematic diagram of permanent magnetic device for enhancing burning of combustion material particles for Embodiments 2 and 4 according to the present invention. As shown in FIG. 6, the four-magnet-set permanent magnetic device 60 includes a left-upper-half barrel magnet 62, a left-lower-half barrel magnet 64, a right-upper-half barrel magnet 66, a right-lower-half barrel magnet 68, and a second hollow cylinder space 70 formed in the four barrel magnets 62, 64, 66, and 68 mentioned above. The second hollow cylinder space 70 is used to receive the combustion material supply pipe 2 connected to a combustion device to pass through. The left-upper-half barrel magnet 62 and the left-lower-half barrel magnet 64 are arranged close to the natural gas application device 4.

The left-upper-half barrel magnet 62 is provided with a left-upper N pole 622 and a left-upper S pole 624. The left-lower-half barrel magnet 64 is provided with a left-lower N pole 642 and a left-lower S pole 644. The right-upper-half barrel magnet 66 is provided with a right-upper S pole 662 and a right-upper N pole 664. The right-lower-half barrel magnet 68 is provided with a right-lower S pole 682 and right-lower N pole 684.

A second contact face 72 is disposed between the right-upper-half barrel magnet 66 and the right-lower-half barrel magnet 68; and a third contact face 74 is disposed between the left-upper-half barrel magnet 62, the left-lower-half barrel magnet 64.

Refer to FIG. 7 for a schematic diagram of the magnetic field lines formed by the four-magnet-set permanent magnetic device for FIG. 6 of Embodiment 4 according to the present invention. As shown in FIG. 7, the second magnetic field lines 90 are formed by the four-magnet-set permanent magnetic device 60. When the combustion material particles 20 passes through the right-upper-half barrel magnet 66, the right-lower-half barrel magnet 68, the second contact face 72, the left-upper-half barrel magnet 62, the left-lower-half barrel magnet 64, and the third contact face 74, due to the existence of the second magnetic field lines 90, the particles 20 are subjected to a series of magnetic field variations, to enhance the stirring and agitations of the particles 20, and to break and split the particles 20 into minute particles 30. Then, after magnetization, the minute particles 30 are formed into combustion material ions 32 carrying positive charges, as described in Embodiment 3. Finally, when the combustion material ions 32 carrying positive charges meet the electrons 34 carrying negative charges produced by the ignition device 8 in the natural gas application device 4, and they react with each other to raise the combustion efficiency of the particles 20.

The third and fourth′ embodiments of the present invention utilize the rare earth permanent magnet rubidium (Rb)-iron (Fe)-boron (B) and the rare earth permanent magnet samariu(Sm)-cobalt(Co). Wherein, the Gauss effect, coercivity, and the catalyst frequency oscillation efficiency for the rare earth permanent magnet rubidium (Rb)-iron (Fe)-boron (B) are better. The permanent magnetic device for enhancing burning of combustion material particles of the present invention is capable of breaking or splitting combustion material molecular cluster into minute particles 30, thus enabling the combustion material mist and the air to mixed more thoroughly, and raising the mixing rate of the combustion material particles 20 and the oxygen molecules, so that the combustion of the combustion material is faster and more complete, to raise the combustion efficiency. Further, the power output of the gas stove can be increased, and the exhausts of monoxide and hydrocarbon can be reduced, in achieving lower energy consumption.

Refer to FIG. 8 for a schematic diagram of a permanent magnetic device for enhancing burning of combustion material particles according to the present invention wherein the combustion material supply pipe is a natural gas supply pipe, and the combustion device is a natural gas application device. Wherein, the natural gas application device includes but not limited to a gas stove, a water heater, or a gas vehicle. Thus, they can be used in the Embodiments mentioned above, and their technical means and functions produced are the same, so they are not described in detail here for brevity.

To further verify the effectiveness of the present invention, experiments are conducted by using Utility Natural Gas (Liquified Natural Gas) and Bottled Gas (Liquified Petroleum Gas), and the results are as shown as follows:

1. Experiment by using Utility Natural Gas on gas water heater, and by installing various numbers of permanent magnetic devices of the present invention:
(1) Glue a thermometer on a water output port of a faucet, turn on the hot water for 30 seconds, then record the final water temperature.
(2) Turn on the hot water for three minutes and record the gas flowing speed shown on the gas meter.
(3) Install two sets of permanent magnetic devices on the gas water heater, then turn on the hot water for 30 seconds, and record the final water temperature.
(4) Install four sets of permanent magnetic devices on the gas water heater, then turn on the hot water for 30 seconds, and record the final water temperature.
(5) Turn on the hot water, adjust the water output temperature of the gas water heater to be the same as that without installing the permanent magnetic devices.
(6) Turn on the hot water for three minutes and record the gas flowing speed shown on the gas meter.

### Results of Experiment

| device installation | | | | | |
|---|---|---|---|---|---|
| number | No sets | | Two sets | Four sets | |
| hot water temperature | 32° | C. | 35° C. | 38° | C. |
| time of using up 10 | 35.4 | sec | | 46.5 | sec |
| liters natural gas | | | | | |

Based on the reading on the gas meter, the natural gas used can be reduced by 31.36%.

2. Experiment by using Bottled Gas on gas water heater, and by installing four sets of permanent magnetic devices of the present invention, and the results are as follows: Before installation, in winter, one bottle of gas is used up every 3 months; while in summer, one bottle of gas is used up every 4.5 months. After installation, only 0.25 bottle of gas is used for 1.5 month, so that it is estimated that one bottle of gas can last for 6 months, in achieving saving of 50%.

3. Experiment by using Bottled Gas on gas stove, and by installing various numbers of permanent magnetic devices of the present invention:
(1) Put 360 ml water of normal room temperature in a stainless steel kettle, then record the time required for heating the water from normal room temperature to 100° C.
(2) Install two sets of permanent magnetic devices of the present invention, and repeat the step (1); install four sets of permanent magnetic devices of the present invention, and repeat the step (1).
(3) Install six sets of permanent magnetic devices of the present invention, and repeat the step (1); install eight sets of permanent magnetic devices of the present invention, and repeat the step (1).

The Results of Experiment are as shown as follows:

| | | two | four | six | eight |
|---|---|---|---|---|---|
| | no sets | sets | Sets | sets | sets |
| time used | 152 s | 138 s | 134 s | 130 s | 129 s |
| saving % | | 9.21% | 11.84% | 14.47% | 15.13% |

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A permanent magnetic device for enhancing burning of combustion material particles, comprising:
a barrel-shape permanent magnetic device, and that includes a near barrel magnet, a distant barrel magnet adjacent to each other, and a first hollow cylinder space formed in a center of the near barrel magnet and the distant barrel magnet respectively, for a combustion material supply pipe to pass through;
the near barrel magnet is provided with a near N pole and a near S pole, the near N pole is adjacent to a combustion device, the distant barrel magnetic is provided with a distant N pole and a distant S pole, the distant N pole is adjacent to the near S pole; and
first magnetic field lines are formed by the barrel-shape permanent magnetic device, the first magnetic field lines are originated from the near N pole, and they enter into the distant S pole through outside space, then the first magnetic field lines pass through the distant N pole, and they enter into the near S pole through a first contact face; when the combustion material particles passes through the distant barrel magnet, the first contact face, and the near barrel magnet, the particles are subject to a series of magnetic field variations, to enhance the stirrings and agitations of the particles, to break and split the particles into minute particles.

2. The permanent magnetic device for enhancing burning of combustion material particles as claimed in claim 1, wherein the near barrel magnet and the distant barrel magnet are barrel-shape structures formed by one of the following respectively: rare earth permanent magnet rubidium(Rb)-iron(Fe)-boron(B) and rare earth permanent magnet samarium(Sm)-cobalt(Co); the combustion material supply pipe is a natural gas supply pipe, the combustion device is a natural gas application device, and the natural gas application device includes one of the following: a gas stove, a water heater, and a gas vehicle.

3. The permanent magnetic device for enhancing burning of combustion material particles as claimed in claim 2, wherein when the agitated and stirred minute particles reach the near N pole, the minute particles are converted into combustion material ions carrying positive charges, and when the combustion material ions carrying positive charges meet the electrons carrying negative charges for an ignition device of the natural gas application device, they react with each other to raise the combustion efficiency of the combustion material particles.

4. The permanent magnetic device for enhancing burning of combustion material particles as claimed in claim 1, wherein the near barrel magnet and the distant barrel magnet are barrel-shape structure, and are made of one of the following respectively: rare earth permanent magnet rubidium (Rb)-iron (Fe)-boron (B) of and rare earth permanent magnet samarium (Sm)-cobalt (Co); the combustion material supply pipe is a combustion gas supply pipe, the combustion device is an internal combustion engine; when the agitated and stirred minute particles reach the near N pole, the minute particles are converted into combustion material ions carrying positive charges, and when the combustion material ions carrying positive charges meet the electrons carrying negative charges for an ignition device of the natural gas application device, they react with each other to raise the combustion efficiency of the combustion material particles.

5. The permanent magnetic device for enhancing burning of combustion material particles as claimed in claim 1, wherein the combustion material particle is one of the following: a kerosene molecule, a gasoline molecule, and a diesel molecule.

6. A permanent magnetic device for enhancing burning of combustion material particles, comprising:
a four-magnetic-set permanent magnetic device, the four-magnetic-set permanent magnetic device includes a left-upper-half barrel magnet, a left-lower-half barrel magnet, a right-upper-half barrel magnet, a right-lower-half barrel magnet, and a second hollow cylinder space formed in the left-upper-half barrel magnet, the left-lower-half barrel magnet, the right-upper-half barrel magnet, and the right-lower-half barrel magnet, the second hollow cylinder space is used for the combustion material supply pipe 2 connected to a combustion device to pass through;
the left-upper-half barrel magnet is provided with a left-upper N pole and a left-upper S pole, the left-lower-half barrel magnet is provided with a left-lower N pole and a left-lower S pole, the right-upper-half barrel magnet is provided with a right-upper S pole and a right-upper N pole, the right-lower-half barrel magnet is provided with a right-lower S pole and right-lower N pole, a second contact face is disposed between the right-upper-half barrel magnet and the right-lower-half barrel magnet, and a third contact face is disposed between the left-upper-half barrel magnet, the left-lower-half barrel magnet; and
second magnetic field lines, formed by the four-magnetic-set permanent magnetic device, when the combustion material particles passes through the right-upper-half barrel magnet, the right-lower-half barrel magnet, the second contact face, the left-upper-half barrel magnet, left-lower-half barrel magnet, and the third contact face, the particles are subject to a series of magnetic field variations, to enhance the stirring and agitations of the particles, to break and split the particles into minute particles.

7. The permanent magnetic device for enhancing burning of combustion material particles as claimed in claim 6, wherein the left-upper-half barrel magnet, the left-lower-half barrel magnet, the right-upper-half barrel magnet and the right-lower-half barrel magnet are barrel-shape structures, and are formed respectively by one of the following: rare earth permanent magnet rubidium (Rb)-iron(Fe)-boron(B) and rare earth permanent magnet samarium (Sm)-cobalt (Co); the second hollow cylinder space is used for a natural gas supply pipe to pass through; the combustion device is a natural gas application device, and the natural gas application device includes one of the following: a gas stove, a water heater, and a gas vehicle.

8. The permanent magnetic device for enhancing burning of combustion material particles as claimed in claim 6, wherein when the agitated and stirred minute particles are magnetized into combustion material ions carrying positive charges, and when the combustion material ions carrying positive charges meet the electrons carrying negative charges for an ignition device of the natural gas application device, they react with each other to raise the combustion efficiency of the combustion material particles.

9. The permanent magnetic device for enhancing burning of combustion material particles as claimed in claim 6, wherein the left-upper-half barrel magnet, the left-lower-half barrel magnet, the right-upper-half barrel magnet and the right-lower-half barrel magnet are barrel-shape structures, and are formed respectively by one of the following: rare earth permanent magnet rubidium (Rb)-iron(Fe)-boron(B) and rare earth permanent magnet samarium(Sm)-cobalt (Co); the second hollow cylinder space is used for a combustion oil supply pipe to pass through; the combustion device is an internal combustion engine, when the agitated and stirred minute particles are magnetized into combustion material ions carrying positive charges, and when the combustion material ions carrying positive charges meet the electrons carrying negative charges for an ignition device of the natural gas application device, they react with each other to raise the combustion efficiency of the combustion material particles.

10. The permanent magnetic device for enhancing burning of combustion material particles as claimed in claim 6, wherein the combustion material particle is one of the following: a kerosene molecule, a gasoline molecule, and a diesel molecule.
